(19) United States
(12) Patent Application Publication
(10) Pub. No.: US 2026/0145757 A1
(43) Pub. Date: May 28, 2026

(54) MOTORCYCLE FOOTREST ADJUSTMENT KIT

(71) Applicant: Guangzhou Binse Network Technology Co., Ltd., Guangzhou (CN)

(72) Inventor: Shuzheng Lao, Guangzhou (CN)

(21) Appl. No.: 19/396,327

(22) Filed: Nov. 20, 2025

(30) Foreign Application Priority Data
Nov. 22, 2024 (CN) 202422874812.0

(51) Int. Cl. B62J 25/06

(52) U.S. Cl. CPC B62J 25/06

(57) ABSTRACT

A motorcycle footrest adjustment kit is provided for installation between a body mounting plate of a motorcycle and a footrest having first and second connecting arms. The kit includes first and second adjustment assemblies, each comprising a plurality of spacer blocks selectable for individual use or for use in a stacked arrangement to adjust the spacing between the body mounting plate and the footrest.

### CROSS REFERENCE TO RELATED APPLICATIONS

This application claims priority to the Chinese patent application No. 202422874812.0, filed on Nov. 22, 2024, the disclosure of which are incorporated by reference herein in its entirety.

### FIELD OF THE DISCLOSURE

The present disclosure relates to motorcycle accessories, and more particularly to a motorcycle footrest adjustment kit.

### BACKGROUND

For motorcyclists, the standard footrest position may not accommodate differences in riders'foot length or riding posture, which can result in discomfort during use. footrest extension kits are used to increase the available foot space by extending the footrests outward, thereby providing a more ergonomic foot placement.

In related technologies, motorcycle footrest adjustment kits are typically installed between a body mounting plate and the footrest to allow the footrest to be extended outward by a certain distance. However, some existing motorcycle footrest adjustment kits may have limited flexibility in adjusting the extension length.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

A motorcycle footrest adjustment kit is provided for installation between a body mounting plate of a motorcycle and a footrest having first and second connecting arms. The kit includes first and second adjustment assemblies, each comprising a plurality of spacer blocks selectable for individual use or for use in a stacked arrangement to adjust the spacing between the body mounting plate and the footrest.

Each first spacer block may be formed with a locating recess on one side and a locating protrusion on the opposite side, the locating structures being coaxially arranged to facilitate stable stacking engagement. The spacer blocks may be provided in different thicknesses, enabling multiple combinations for fine adjustment of the footrest position. The spacer blocks may also include connection holes aligned with corresponding through-holes of the connecting arms and the body mounting plate, allowing a fastener to extend through the assembly.

In certain configurations, the body mounting plate and the connecting arms may further include complementary locating features configured to engage with the locating structures of the spacer blocks to enhance positional stability. The connecting arms may further include connection portions having outer contours corresponding to the outer contours of the spacer blocks.

The adjustment kit may additionally include first and second adapter members. The fasteners used for attaching the spacer blocks may have predetermined lengths suitable for accommodating either stacked blocks or a single block. When only one block is used, an adapter member may be installed on a side of the corresponding connecting arm opposite the body mounting plate to ensure proper fastening engagement.

### BRIEF DESCRIPTION OF THE DRAWINGS

FIG. 1 is an exploded view of an example motorcycle footrest adjustment kit.

FIG. 2 illustrates an exploded view in which a single spacer block is installed.

FIG. 3 illustrates a stacked configuration of the first and second adjustment assemblies.

FIG. 4 is a perspective view of the first and second spacer blocks.

FIG. 5 is another perspective view of the first and second spacer blocks.

### NUMERAL REFERENCES IN THE DRAWINGS

10—first adjustment assembly; 11—first spacer block; 111—first connection hole; 112—first locating recess; 113—first locating protrusion;
20—second adjustment assembly; 12—second spacer block; 121—second connection hole;
21—first fastener; 22—second fastener;
30—first adapter member; 40—second adapter member;
200—body mounting plate; 201—second locating recess; 202—third through-hole; 203—fourth through-hole;
300—footrest; 301—first connecting arm; 3011—connection portion; 3012—first through-hole; 3013—first locating protrusion; 302—second connecting arm; 3021—second through-hole.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “comprising” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be comprised in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

In the related art, a motorcycle footrest has two connecting arms. One of the two connecting arms has a locating protrusion on the side facing a body mounting plate. The body mounting plate has a locating recess. The locating protrusion of the connecting arm and the locating recess of the body mounting plate are mutually adapted in shape. The locating protrusion can be inserted into the locating recess, providing a positioning point between the footrest and the body mounting plate for easy fixed connection. A fastener can penetrate the connecting arm and connects to the body mounting plate, thereby installing the footrest on the body mounting plate.

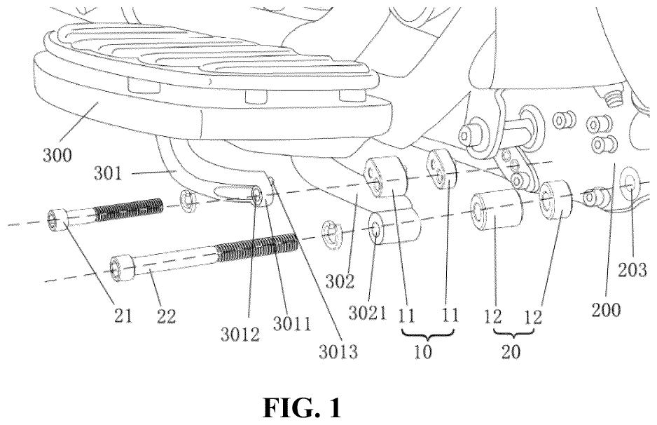

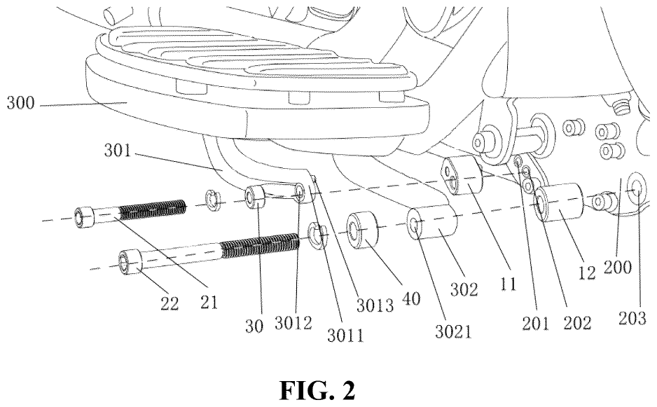

Referring to FIGS. 1 and 2, an embodiment of the present disclosure provides a motorcycle footrest adjustment kit, which is installed between the body mounting plate 200 and the footrest 300. The footrest 300 has a first connecting arm 301. The motorcycle footrest adjustment kit includes a first adjustment assembly 10, which includes one or more first spacer blocks 11. The one or more first spacer blocks 11 can be selectively set individually or stacked in the thickness direction between the body mounting plate 200 and the first connecting arm 301 for adjusting the distance between the body mounting plate 200 and the footrest 300.

Each first spacer block 11 in the first adjustment assembly 10 has a preset thickness. When the rider needs to adjust an outward extension length of the footrest, each first spacer block 11 can be selectively installed between the body mounting plate 200 and the footrest 300. When only one first spacer block 11 is installed, the outward extension length of the footrest is equal to the thickness of the first spacer block 11. When multiple first spacer blocks 11 are installed simultaneously between the body mounting plate 200 and the footrest 300, the corresponding number of first spacer blocks 11 are stacked in the thickness direction, accumulating their thickness to achieve a greater extension length. By selectively installing one or more first spacer blocks 11, the rider can adjust the footrest extension distance according to their individual needs to meet the requirements of different body types and riding habits, enhancing the operability of the motorcycle footrest adjustment kit.

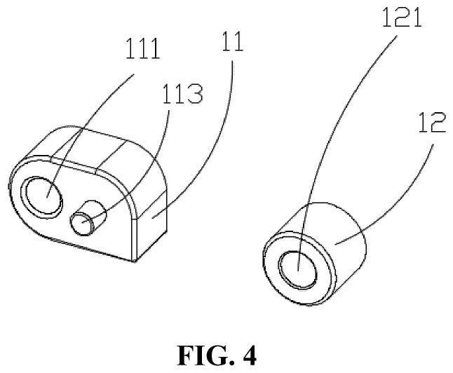

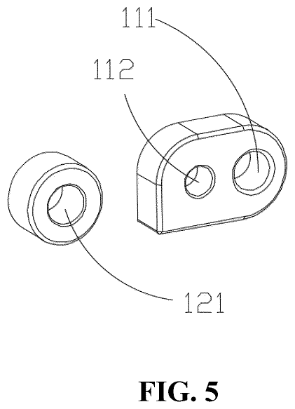

Referring to FIGS. 4 and 5, a first locating recess 112 is formed on one side of the first spacer block 11, and a first locating protrusion 113 is formed on the other side. The first locating protrusion 113 and the first locating recess 112 are coaxially arranged in the thickness direction. When multiple first spacer blocks 11 are stacked, the first locating protrusion 113 of one first spacer block 11 is inserted into the first locating recess 112 of the adjacent first spacer block 11.

In one embodiment, the first spacer block 11 has one first locating recess 112 on the side facing the first connecting arm 301, and one first locating protrusion 113 on the side facing the body mounting plate 200. When installing the motorcycle footrest adjustment kit, the first locating recess 112 and first locating protrusion 113 are coaxially arranged and provide a structural basis for the stacking of multiple first spacer blocks 11, providing positioning points in the thickness direction for each first spacer block 11 and adjacent first spacer blocks 11, ensuring that multiple first spacer blocks 11 fit tightly together and are not easily displaced during connection.

Multiple first spacer blocks 11 can have the same or different thicknesses. When multiple first spacer blocks 11 have the same thickness, when installing a single first spacer block 11, the outward extension length of the footrest 300 is equal to the thickness of that single first spacer block 11; when installing multiple first spacer blocks 11, the outward extension length of the footrest 300 is the sum of the thicknesses of the stacked first spacer blocks 11.

When multiple first spacer blocks 11 have different thicknesses, when installing a single first spacer block 11, different thicknesses can be selected, resulting in different outward extension lengths of the footrest 300; when installing multiple first spacer blocks 11, the outward extension length of the footrest 300 is the sum of the thicknesses of the stacked first spacer blocks 11.

The thickness range of the first spacer block 11 is 0.3 to 0.75 inches or 0.5 to 1.2 inches. In some embodiments, the thickness range of one first spacer block 11 is 0.3 to 0.75, and the thickness range of another first spacer block 11 is 0.5 to 1.2 inches. The plurality of first spacer block 11 may have different lengths, thereby providing different outward extension length of the footrest 300.

The range of 0.3 to 0.75 inches is equivalent to 7.62 to 19.05 millimeters in SI units, and the range of 0.5 to 1.2 inches is equivalent to 12.7 to 30.48 millimeters in SI units. In one embodiment, the thickness of the first spacer block 11 of the first adjustment assembly 10 is preferably 0.5 inches, 0.75 inches, or 1 inch, i.e., 12.7 millimeters, 19.05 millimeters, or 25.4 millimeters.

The motorcycle footrest adjustment kit also includes a first fastener 21. A first through-hole 3012 is defined in the first connecting arm 301. A third through-hole 202 is defined in the body mounting plate 200. A first connection hole 111 is defined in each first spacer block 11. The first fastener 21 extends sequentially through the first through-hole 3012, one or more first connection holes 111, and the third through-hole 202 to secure the first spacer block 11 between the body mounting plate 200 and the footrest 300.

A second locating recess 201 is defined in the body mounting plate 200. A second locating protrusion 3013 is provided on the first connecting arm 301. The first locating protrusion 113 is inserted into the second locating recess 201, and the second locating protrusion 3013 is inserted into the first locating recess 112, thereby connecting the first spacer block 11 between the body mounting plate 200 and the first connecting arm 301.

When the motorcycle footrest adjustment kit is not installed, the second locating protrusion 3013 and the second locating recess 201 of the body mounting plate 200 are mutually compatible in shape, that is, the second locating protrusion 3013 can be inserted into the second locating recess 201 to provide a locating point for the connection between the footrest 300 and the body mounting plate 200. When installing the motorcycle footrest adjustment kit, the first locating recess 112 and the first locating protrusion 113 of the first spacer block 11 serve two purposes. Firstly, the first locating protrusion 113 at one side of the first spacer block 11 facing the body mounting plate 200 can be inserted into the second locating recess 201 of the body mounting plate 200. In the same time, the second locating protrusion 3013 can be inserted into the first locating recess 112 of the first spacer block 11. Secondly, when multiple first spacer blocks 11 are stacked in the thickness direction, the first locating protrusion 113 of one first spacer block 11 is inserted into the first locating recess 112 of the adjacent first spacer block 11, thereby making each first spacer block 11 less prone to displacement when multiple first spacer blocks 11 are stacked in the thickness direction.

Furthermore, the first connecting arm 301 includes a connection portion 3011 at a distal end. An outer contour of the connection portion 3011 faces the first spacer block 11 is similar to that of the first spacer block 11.

This similar outer contour of the connection portion 3011 and the first spacer block 11 facilitates stable contact and a neat shape when the first connecting arm 301 and the first spacer block 11 are connected, reducing uneven stress during stacking and ensuring stability and overall aesthetics after installation.

The motorcycle footrest adjustment kit also includes a second adjustment assembly 20. The footrest 300 further includes a second connecting arm 302. The second adjustment assembly 20 includes one or more second spacer blocks 12, which can be selectively installed individually or stacked in the thickness direction between the body mounting plate 200 and the second connecting arm 302. The thickness of each second spacer block 12 corresponds one-to-one with the thickness of each first spacer block 11.

To more stably connect the motorcycle's footrest 300 to the body mounting plate 200, the footrest 300 typically has two connecting arms: a first connecting arm 301 and a second connecting arm 302. To accommodate the two connecting arms of the footrest 300, the motorcycle footrest adjustment kit also has one or more first spacer blocks 11 and one or more second spacer block 12. The one or more first spacer blocks 11 can be individually sandwiched or stacked between the first connecting arm 301 and the body mounting plate 200, while the one or more second spacer block 12 can be individually sandwiched or stacked between the second connecting arm 302 and the body mounting plate 200.

The motorcycle footrest adjustment kit also includes a second fastener 22. The second connecting arm 302 has a second through-hole 3021. The body mounting plate 200 has a fourth through-hole 203. Each second spacer block 12 has a second connection hole 121. The second fastener 22 passes sequentially through the second through-hole 3021, one or more second connection holes 121, and the fourth through-hole 203 to secure the second spacer block 12 between the body mounting plate 200 and the second connecting arm 302.

To stack multiple second spacer blocks 12 in the thickness direction, each second spacer block 12 has a second connection hole 121, allowing the second fastener 22 to connect the stacked the second spacer blocks 12 in series.

In one embodiment, the first fastener 21 has a preset length adapted to a total thickness of two stacked first spacer blocks 11, and the second fastener 22 has a preset length adapted to a total thickness of two stacked second spacer blocks 12. The motorcycle footrest adjustment kit also includes a first adapter member 30 and a second adapter member 40. When one single first spacer block 11 is placed between the body mounting plate 200 and the first connecting arm 301, the first adapter member 30 is installed by the first fastener 21 on the side of the first connecting arm 301 away from the body mounting plate 200, thereby adapting to the preset length of the first fastener 21. When one single second spacer block 12 is placed between the body mounting plate 200 and the second connecting arm 302, the second adapter member 40 is installed by the second fastener 22 on the side of the second connecting arm 302 away from the body mounting plate 200, thereby adapting to the preset length of the second fastener 22.

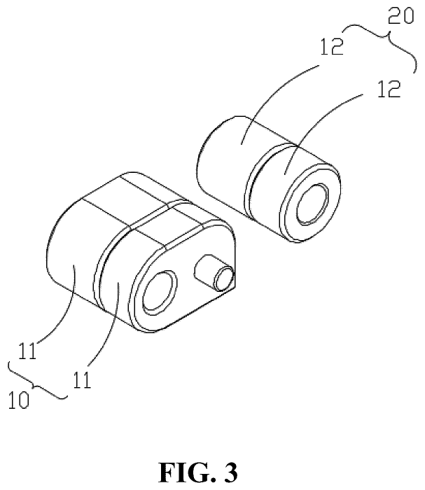

Referring to FIGS. 2 and 3, in some embodiments, at least two stacked first spacer blocks 11 may include a thick first spacer block with a first thickness and a thin first spacer block with a second thickness. The first thickness is greater than the second thickness. When only the thick first spacer block is installed between the body mounting plate 200 and the first connecting arm 301, the first adapter member 30 is mounted on the side of the first connecting arm 301 opposite to the body mounting plate 200 via the first fastener 21, thereby adapting to the preset length of the first fastener 21. Similarly, at least two stacked second spacer blocks 12 may include a thick second spacer block with the first thickness and a thin second spacer block with the second thickness. When only one thick second spacer block is installed between the body mounting plate 200 and the second connecting arm 302, the second adapter member 40 is mounted on the side of the second connecting arm 302 opposite to the body mounting plate 200 via the second fastener 22, thereby adapting to the preset length of the second fastener 22.

In one embodiment, the first adjustment assembly 10 has two first spacer blocks 11, and the second adjustment assembly 20 has two second spacer blocks 12. In assembly, the first fastener 21 sequentially penetrates the first connecting arm 301, the two first spacer blocks 11, and the body mounting plate 200, while the second fastener 22 sequentially penetrates the second connecting arm 302, the two second spacer blocks 12, and the body mounting plate 200. The first fastener 21 and the second fastener 22 are perfectly matched to the multi-layer connection of the aforementioned components without any length margin. This is because the lengths of the first fastener 21 and the second fastener 22 are adapted to the stacked first spacer blocks 11 and second spacer blocks 12. When the first spacer block 11 or the second spacer block 12 is installed alone to extend the footrest 300, the first fastener 21 or the second fastener 22 has a length margin, and the thickness of the first adapter member 30 and the second adapter member 40 can respectively compensate for the length margin of the first fastener 21 and the second fastener 22, thus ensuring a compact and stable connection between the components when the first spacer block 11 or the second spacer block 12 is installed alone.

In other embodiments, the first adjustment assembly 10 includes three or more first spacer blocks 11, and the second adjustment assembly 20 includes three or more second spacer blocks 12. The length of the first fastener 21 is adapted to the thickness of all the stacked first spacer blocks 11, and the length of the second fastener 22 is adapted to the thickness of all the stacked second spacer blocks 12. One or more first spacer blocks 11 or second spacer blocks 12 are installed between the footrest 300 and the body mounting plate 200.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described. The disclosure claimed is:

1. A motorcycle footrest adjustment kit configured to be installed between a body mounting plate of a motorcycle and a footrest having a first connecting arm, the motorcycle footrest adjustment kit comprising:
a first adjustment assembly comprising a plurality of first spacer blocks, each of the first spacer blocks being selectively usable individually or in a stacked arrangement along a thickness direction between the body mounting plate and the first connecting arm to adjust a distance between the body mounting plate and the footrest.

2. The motorcycle footrest adjustment kit according to claim 1, wherein each first spacer block comprises a first locating recess on a first side and a first locating protrusion on a second side opposite to the first side, the first locating recess and the first locating protrusion are coaxially aligned along the thickness direction, and when two or more of the plurality of first spacer blocks are stacked, the first locating protrusion of one first spacer block is inserted in the first locating recess of an adjacent first spacer block.

3. The motorcycle footrest adjustment kit according to claim 1, wherein the plurality of first spacer blocks have different thicknesses.

4. The motorcycle footrest adjustment kit according to claim 1, wherein one of the plurality of the first spacer blocks has a thickness within a range of 0.3 to 0.75 inches, and another one of the plurality of the first spacer blocks has a thickness within a range of 0.5 to 1.2 inches.

5. The motorcycle footrest adjustment kit according to claim 1, further comprising a first fastener, and wherein the first connecting arm defines a first through-hole, the body mounting plate defines a third through-hole, and each first spacer block comprises a first connection hole, the first fastener extending successively through the first through-hole, one or more first connection holes of one or more of the plurality of first spacer blocks, and the third through-hole.

6. The motorcycle footrest adjustment kit according to claim 2, wherein the body mounting plate further comprises a second locating recess, and the first connecting arm further comprises a second locating protrusion, the first locating protrusion being receivable in the second locating recess, and the second locating protrusion being receivable in the first locating recess.

7. The motorcycle footrest adjustment kit according to claim 1, wherein the first connecting arm comprises a connection portion having an outer contour facing the first spacer blocks that is similar to an outer contour of the first spacer blocks facing the body mounting plate.

8. The motorcycle footrest adjustment kit according to claim 1, further comprising a second adjustment assembly, wherein the footrest further comprises a second connecting arm, the second adjustment assembly comprising a plurality of second spacer blocks selectively usable individually or in a stacked arrangement between the body mounting plate and the second connecting arm, and wherein the plurality of second spacer blocks have thicknesses corresponding to the thicknesses of the plurality of first spacer blocks.

9. The motorcycle footrest adjustment kit according to claim 8, further comprising a second fastener, and wherein the second connecting arm comprises a second through-hole, the body mounting plate comprises a fourth through-hole, and each second spacer block comprises a second connection hole, the second fastener extending successively through the second through-hole, one or more second connection holes of one or more of the plurality of second spacer blocks, and the fourth through-hole.

10. The motorcycle footrest adjustment kit according to claim 9, further comprising a first adapter member and a second adapter member, wherein the first fastener has a predetermined length to accommodate two stacked first spacer blocks, and the second fastener has a predetermined length to accommodate two stacked second spacer blocks;
wherein the two stacked first spacer blocks comprise a thick first spacer block with a first thickness and a thin first spacer block with a second thickness, the first thickness is greater than the second thickness, when only the thick first spacer block is installed between the body mounting plate and the first connecting arm, the first adapter member is mounted on a side of the first connecting arm opposite to the body mounting plate with the second fastener extending therethrough; and
wherein, the two stacked second spacer blocks comprise a thick second spacer block with the first thickness and a thin second spacer block with the second thickness, when only the thick second spacer block is installed between the body mounting plate and the second connecting arm, the second adapter member is mounted on a side of the second connecting arm opposite to the body mounting plate with the second fastener extending therethrough.

11. A motorcycle footrest adjustment kit configured to be installed between a body mounting plate of a motorcycle and a footrest having a first connecting arm, the motorcycle footrest adjustment kit comprising: and

12. The motorcycle footrest adjustment kit according to claim 11, wherein each first spacer block comprises a first locating recess on a first side and a first locating protrusion on a second side opposite to the first side, the first locating recess and the first locating protrusion are coaxially aligned along the thickness direction, and when the at least two first spacer blocks are stacked, the first locating protrusion of one first spacer block is inserted in the first locating recess of an adjacent first spacer block.

13. The motorcycle footrest adjustment kit according to claim 12, wherein the body mounting plate further comprises a second locating recess, and the first connecting arm further comprises a second locating protrusion, the first locating protrusion being receivable in the second locating recess, and the second locating protrusion being receivable in the first locating recess.

14. The motorcycle footrest adjustment kit according to claim 12, wherein a thickness of one of the at least two first spacer blocks is different to that of another one of the at least two first spacer blocks.

15. The motorcycle footrest adjustment kit according to claim 11, wherein the first connecting arm defines a first through-hole, the body mounting plate defines a third through-hole, and each first spacer block defines a first connection hole, and wherein the first fastener extends sequentially through the first through-hole, the first connection holes of the at least two first spacer blocks, and the third through-hole.

16. The motorcycle footrest adjustment kit according to claim 11, further comprising a second adjustment assembly, wherein the footrest further comprises a second connecting arm, the second adjustment assembly comprises a plurality of second spacer blocks, at least two of the second spacer blocks being configured to be stacked along a thickness direction between the body mounting plate and the second connecting arm, and a total stacked thickness of the at least two second spacer blocks being equal to a total stacked thickness of the at least two first spacer blocks.

17. The motorcycle footrest adjustment kit according to claim 16, further comprising a second fastener, and wherein the second connecting arm comprises a second through-hole, the body mounting plate comprises a fourth through-hole, and each second spacer block comprises a second connection hole, and the second fastener extends successively through the second through-hole, the second connection holes of the at least two second spacer blocks, and the fourth through-hole.

18. A motorcycle footrest adjustment kit configured to be installed between a body mounting plate of a motorcycle and a footrest having a first connecting arm, the motorcycle footrest adjustment kit comprising:
at least one first spacer block, a first side of the at least one first spacer block being connected to the body mounting plate, and a second side of the at least one first spacer block being connected to the first connecting arm;
a first adapter member mounted on a side of the first connecting arm opposite to the body mounting plate; and
the first adapter member, the first connecting arm, the at least one first spacer block, and the body mounting plate to secure the at least one first spacer block between the body mounting plate and the footrest.

19. The motorcycle footrest adjustment kit according to claim 18, further comprising a second adjustment assembly, a second adapter member, and a second fastener, and wherein the footrest further comprises a second connecting arm, the second adjustment assembly comprises at least one second spacer block mounted between the body mounting plate and the second connecting arm, the second adapter member is mounted on a side of the second connecting arm opposite to the body mounting plate, and the second fastener extending through the second adapter member, the second connecting arm, the at least one second spacer block, and the body mounting plate for securing the at least one second spacer block between the body mounting plate and the footrest.

20. The motorcycle footrest adjustment kit according to claim 19, wherein the first fastener has a predetermined length to accommodate the at least one first spacer block and the first adapter member, and the second fastener has a predetermined length to accommodate the at least one second spacer block and the second adapter member.
